(19) United States
(12) Patent Application Publication
(10) Pub. No.: US 2019/0169804 A1
(43) Pub. Date: Jun. 6, 2019

(54) Road-building machine and method for operating a road-building machine

(71) Applicant: Dynapac GmbH, Wardenburg (DE)

(72) Inventors: Hauke Brammer, Grosskneten (DE); Rainer Kruse, Harkebrugge (DE)

(73) Assignee: Dynapac GmbH, Wardenburg (DE)

(21) Appl. No.: 16/202,462

(22) Filed: Nov. 28, 2018

(30) Foreign Application Priority Data
Dec. 4, 2017 (DE) 102017011159.6

(51) Int. Cl. E01C 23/088; E01C 23/12; B65G 43/10; G05B 19/042

(52) U.S. Cl. CPC E01C 23/088; E01C 23/127; G05B 2219/2641; G05B 19/042; G05B 2219/2621; B65G 43/10

(57) ABSTRACT

A method by means of which the paving result of the road covering can be improved. For the production of a road covering, road-building material is supplied by a pivoting conveyor of a feeder to a supply container of a road paver. In the case of a relative movement between the feeder and the road paver, the pivoting conveyor has to be manually readjusted, which can result in irregularities in the road covering. This is achieved in that the container of the at least one construction vehicle is detected by at least one sensor unit of the road-building machine.

### CROSS REFERENCE TO RELATED APPLICATIONS

This application claims the benefit of and priority on German Patent Application No. 10 2017 011 159.6 having a filing date of 4 Dec. 2017.

### BACKGROUND OF THE INVENTION

### Technical Field

The invention relates to a method for operating a road-building machine, in particular a feeder or a road milling machine, having a running gear and having a pivoting conveyor which is pivotably fastened to the road-building machine, wherein material, in particular road-building material or milled-off road material, is conveyed by the pivoting conveyor into a container of at least one further construction vehicle which moves with or relative to the road-building machine. Furthermore, the invention relates to a road-building machine, in particular a feeder or a road milling machine, having a running gear and having a pivoting conveyor which is pivotably fastened to the road-building machine, wherein, by virtue of the pivoting conveyor, material, in particular road-building material or milled-off road material, can be conveyed away by the pivoting conveyor into a container of at least one further construction vehicle which moves with or relative to the road-building machine.

### Prior Art

Surface coverings or road superstructures which can be walked on or driven over, for example, such as, in particular, carriageway coverings or road wearing courses or road surfacings, are customarily produced from materials such as, preferably, asphalt.

To produce the material layer applied to a substrate, use is generally made of road pavers. Removal of such a material layer from a substrate calls for the use of road milling machines.

The material is customarily at least substantially continuously supplied to the road paver in order to ensure a uniform and as uninterrupted as possible material application. As a buffer for relatively short delivery interruptions, the road paver generally has a container or supply container, which is also referred to as a material bunker. In this respect, the material is customarily loaded into this supply container by a feeder with the aid of a conveyor. In this respect, the feeder has a conveyor which transports the material, in particular the road-building material, to the supply container of the road paver.

Feeders of the type claimed here customarily have a pivoting conveyor which is movably articulated on the chassis. The road-building material is ejected by this pivoting conveyor counter to a paving direction from a supply container of the feeder into the bunker or supply container of the road paver following the feeder. For this purpose, the road-building material is conveyed on the pivoting conveyor to an ejection point of the pivoting conveyor, wherein the ejection point has to be oriented in the direction of the supply container of the road paver.

To ensure that the pivoting conveyor of the feeder can eject the road-building material into the supply container of the road paver without material loss, the relative position of the feeder or of the ejection point of the pivoting conveyor to the supply container of the road paver has to be readjusted during the operation of the road paver. This applies in particular if the feeder and the road paver move relative to one another, as is the case during cornering, for example. As long as the feeder moves ahead of the road paver in a straight line without one of the two road-building machines carrying out an accelerating movement, the position of the pivoting conveyor relative to the road paver does not have to be changed.

For a controlled readjustment of the pivoting conveyor during the operation of the road-building machines, an operator has to monitor both the movement of the road-building machine and the movement of the feeder and correspondingly regulate the orientation of the pivoting conveyor during a relative positional change. This manual readjustment of the pivoting conveyor can lead to operating errors particularly over relatively long operating periods, which is always associated with a material loss. Particularly the loss of road-building material or the ejection of road-building material next to the supply container can result in an unsatisfactory paving result of the road covering.

Road milling machines serve to remove or mill off a road covering or the like from a substrate. The material removed by a milling drum is likewise ejected by a pivoting conveyor onto a truck, for example. Here, too, the relative position of the pivoting conveyor to the truck has to be controlled and, where appropriate, readjusted during the milling operation.

### BRIEF SUMMARY OF THE INVENTION

The object on which the present invention is based is to provide a method for operating a road-building machine, and a road-building machine, by means of which the paving result for a road covering can be improved in relation to previous methods.

A method for achieving this object is a method for operating a road-building machine, in particular a feeder or a road milling machine, having a running gear and having a pivoting conveyor which is pivotably fastened to the road-building machine, wherein material, in particular road-building material or milled-off road material, is conveyed by the pivoting conveyor into a container of at least one further construction vehicle which moves with or relative to the road-building machine, characterized in that the container of the at least one construction vehicle is detected by at least one sensor unit of the road-building machine. Accordingly, there is provision that the container of the at least one construction vehicle is detected by at least one sensor unit of the road-building machine. Moreover, it is preferably conceivable that, for a targeted pivoting or readjustment of the pivoting conveyor or for determining a material filling level of the container, the container of the construction vehicle is detected by at least one sensor unit, preferably a stereoscopic camera, an imaging unit, distance sensors or the like. By virtue of this detection, it is possible at any time of the operation for the position of the container and thus the relative position of the container to the pivoting conveyor to be determined by the control device. For this purpose, the concrete shape of the container or reference body or reference signals for the recognition of the container as such can be predetermined for the sensor unit. Particularly the two- or three-dimensional shape of the container can be detected by a stereoscopic camera. Moreover, the material filling level in the container can be determined with a high degree of accuracy by the stereoscopic camera.

Moreover, the sensor unit detects the orientation and/or the distance of the container of the construction vehicle relative to the ejection point of the pivoting conveyor. By knowing this information, the pivoting conveyor can be accurately oriented relative to the container in such a way that a reliable and effective material supply from the pivoting conveyor into the container can occur. A further advantage of the detection of the container by the at least one sensor unit consists in the fact that the material filling level of the container can be detected. As soon as a critical material filling level is exceeded, a signal can be generated via a control unit to the pivoting conveyor or the conveyor belt in order to throttle or regulate the material delivery rate. If, by contrast, a critical and/or predetermined detected material quantity is fallen below, a signal can be generated which results in an increase in the material delivery rate. If the sensor unit detects a uniform material quantity, precisely as much material is paved as is replenished into the container by the pivoting conveyor. For the case that material is ejected onto the loading surface of a construction vehicle by the pivoting conveyor of a milling machine, the sensor unit can detect when the loading surface or the container is filled.

In addition, there can be provision that the pivoting conveyor, in particular the ejection point of the pivoting conveyor, is pivoted in an automated manner relative to the container of a further construction vehicle by a control unit. This automated pivoting of the pivoting conveyor means that the constant supervision of the relative position of the pivoting conveyor and of the construction vehicle by the operator and the manual readjustment are superfluous. The automated readjustment makes the operation of the road-building machine substantially more reliable, with the result that ultimately a better paving result can be achieved. In particular, a more targeted readjustment can be realized by the automation, with the result that the material loss can be minimized. The detection of the container of the construction vehicle means that it is not absolutely necessary that the road-building machine travels directly in front of or behind the construction vehicle. Rather, the road-building machine can also be oriented with a slight offset to the construction vehicle. For example, it is conceivable that a feeder travels obliquely in front of a road paver and the sensor unit detects the container of the road paver in the meantime for an automatic readjustment of the pivoting conveyor. It is equally conceivable that the feeder travels in front of two road pavers and detects both containers of the road pavers and in particular the material filling levels thereof are detected by the at least one sensor unit.

There can also preferably be provision that, as a result of an operator actuating at least one signal transmitter, preferably a button, a touch panel or a remote control, positions of the pivoting conveyor relative to a longitudinal axis of the road-building machine are reached in an automated manner by the pivoting conveyor, wherein the positions are determined in particular before putting the road-building machine into operation. The storing of predetermined positions means that the pivoting conveyor can be moved in a simple, rapid and reliable manner by actuating the signal transmitter. Furthermore, the pivoting of the pivoting conveyor according to the stored positions is configured to be reproducible, and therefore a correspondingly automated readjustment becomes particularly simple. The signal transmitters, in particular buttons or a touch panel, can be directly actuated by the operator from a driver's station. Moreover, it is conceivable that the operator moves the pivoting conveyor into the various positions via a remote control away from the road-building machine. This simple actuation of a single signal transmitter means that there is no longer a need, as previously, for the position of the pivoting conveyor to be set by inputting a plurality of parameters. There can be provision according to the invention that positions for the pivoting conveyor are predetermined, which positions relate to two or more road pavers to be supplied with road-building material and can be called up via corresponding signal transmitters or commands. By virtue of a multiplicity of stored positions it is possible for the pivoting conveyor to be correspondingly pivoted in an automated manner for a multiplicity of situations or relative positioning between the road paver and the construction machine.

The invention can preferably also make provision that the, preferably predetermined, positions of the pivoting conveyor and/or control signals for actuators, in particular electrical, mechanical or hydraulic drives, for pivoting the pivoting conveyor into the chosen position are stored in at least one memory of the control unit and are called up by actuating the signal transmitter, with the result that the pivoting conveyor is pivoted by the actuators into the chosen position in dependence on its current position. The information stored in the memory of the control unit can be changed or adapted at any time by an operator in order, where appropriate, to react to changing paving conditions. Furthermore, it is conceivable that, for the operation or for the production of a road covering, a complete program for the control unit of the pivoting conveyor relative to the container of the road paver is stored in the memory. By virtue of this complete automation of the readjustment of the pivoting conveyor, it is possible in a cost-effective manner for the readjustment to be configured to be particularly reliable and specific.

A further exemplary embodiment of the present invention makes provision that the pivoting conveyor is pivoted from one position into a chosen positon, wherein material conveyed during the pivoting of the pivoting conveyor is ejected at least predominantly, preferably exclusively, into the container of the construction vehicle, and wherein for this purpose particularly the conveying speed of the pivoting conveyor is at least temporarily adapted.

Moreover, a further exemplary embodiment of the present invention can make provision that a warning signal is generated by the control unit as soon as it is determined by the sensor unit that the relative positon of the container to the pivoting conveyor deviates from a predetermined position, in particular departs from a predetermined tolerance range for the position. This tolerance range or the critical position can be stored in the control unit before putting the road-building machine into operation. It is ensured in this way that an operator is put into a position to promptly recognize an incorrect readjustment of the pivoting conveyor and to act accordingly.

Furthermore, the invention can make provision that the pivoting conveyor is automatically readjusted, preferably continuously, corresponding to the position of the container, by the control unit on the basis of the position of the container determined by the sensor unit by means of actuators, in particular electrical, mechanical or hydraulic drives.

Furthermore, it can be conceivable according to the invention that the position of the container is determined by the at least one sensor unit on the pivoting conveyor by at least one, in particular electromagnetic, optical or acoustic, signaling means which is arranged on the container, wherein the pivoting conveyor is, where appropriate, readjusted in dependence on the position of the container. By using a plurality of alternative signaling means, it is possible, for different situations, for the most advantageous to be selected.

A road-building machine for achieving the object stated at the outset is a road-building machine, in particular feeder or road milling machine, having a running gear and having a pivoting conveyor which is pivotably fastened to the road-building machine, wherein, by virtue of the pivoting conveyor, material, in particular road-building material or milled-off road material, can be conveyed away by the pivoting conveyor into a container of at least one further construction vehicle which moves with or relative to the road-building machine, characterized in that the pivoting conveyor has at least one sensor unit, such as, for example, an imaging unit, a stereoscopic camera or a distance sensor, by means of which the container of the construction vehicle can be detected for a targeted pivoting or a readjustment of the pivoting conveyor or for determining the filling level of the conveyer. Accordingly, there is provision that the pivoting conveyor has at least one sensor unit, such as, for example, an imaging unit, a stereoscopic camera or a distance sensor, by means of which the container of the construction vehicle can be detected for a targeted pivoting or a readjustment of the pivoting conveyor or for determining the filling level of the container. For example, the imaging unit can be a camera which is sensitive in the visible or in the infrared spectral range. As a result of this direct detection of the container by a sensor unit, a fixed relationship or connection between the container and the pivoting conveyor can be produced at least virtually.

By knowing the relative positioning of the container to the pivoting conveyor, actuators of the pivoting conveyor, in particular electrical, mechanical or hydraulic drives, can be correspondingly automatically readjusted, preferably continuously. A manual readjustment of the pivoting conveyor is thus superfluous. This automation of the detection of the container and of the readjustment means that the operation of the road-building machines can be configured to be particularly reliable and cost-effective.

Furthermore, it is conceivable according to the invention that the pivoting conveyor, in particular the ejection point of the pivoting conveyor, can be pivoted in an automated manner relative to the container of the further construction vehicle by a control unit, specifically in such a way that the conveyed material falls into the container. Owing to this automated pivoting or readjustment, the construction machine having the pivoting conveyor can continuously follow the container of the further construction vehicle without a material loss or without the material being ejected next to the container. For the case that the feeder must supply more than one road-building machine with road-building material, in particular two machines, the just described pivoting conveyor can also be readjusted to a plurality of containers in alternation. The plurality of containers are likewise to be detected by the at least one sensor unit, in particular simultaneously or in alternation.

Furthermore, there can be provision that the pivoting conveyor is assigned at least one signal transmitter, preferably a button, a touch panel or a remote control, by the actuation of which the pivoting conveyor can be moved in an automated manner into a predetermined position relative to a longitudinal axis of the road-building machine. The button or the touch panel is advantageously situated directly in a driver's or operator's station of the road-building machine, with the result that the operator can operate the pivoting conveyor in a simple manner. Alternatively, there can be provision that the operator controls the pivoting conveyor via the remote control away from the road-building machine. Thus, it is conceivable for example that the pivoting conveyor is controlled from the further construction vehicle which has the container. A high degree of automation can be realized in this way, which leads, on the one hand, to cost savings and, on the other hand, makes the operation of the road-building machines more reliable and more efficient.

A further exemplary embodiment of the present invention can make provision that the control unit has at least one data memory in which positions of the pivoting conveyor which can be chosen by an operator and/or control signals for actuators, in particular electrical, mechanical or hydraulic drives, for pivoting the pivoting conveyor into the chosen position can be stored and can be called up by actuating the at least one signal transmitter, wherein the pivoting conveyor can be pivoted into the chosen position. This data memory, which is an electrical data memory, can be directly integrated into the control unit or be coupled to the control unit as an interchangeable data memory. Thus, for example, predetermined positions of the pivoting conveyor and/or control signals can be produced beforehand at another point so as then to pass them to the control unit on the road-building machine. This flexible data exchange means that changing paving conditions can be responded to in a simple and rapid manner. It is additionally conceivable that data are transmitted to the data memory via a wireless connection for the operation of the road-building machine.

Finally, a further advantageous exemplary embodiment of the present invention can make provision that the at least one container has arranged thereon at least one, in particular electromagnetic, optical or acoustic, signaling means which can be detected by the at least one sensor unit and the position of the container relative to the pivoting conveyor can be determined from the detected signals of the signaling means.

### BRIEF DESCRIPTION OF THE DRAWINGS

A preferred exemplary embodiment of the present invention is explained in more detail below with reference to the drawing, in which:

FIG. 1 shows a side view of a feeder having a pivoting conveyor, and

FIG. 2 shows a view of the feeder according to FIG. 1.

### DETAILED DESCRIPTION OF PREFERRED EMBODIMENTS

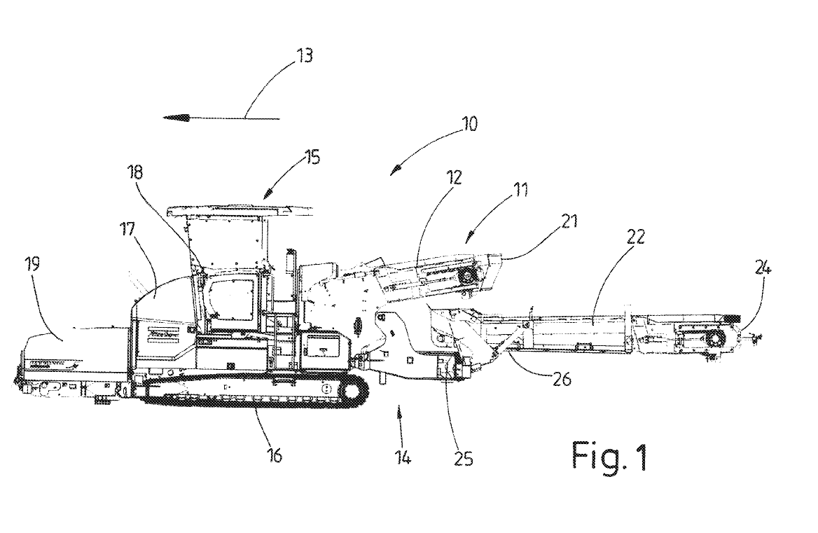

A paving train for producing a surface covering or a road covering composed of asphalt customarily comprises at least one road paver, which is not illustrated in the drawing, and at least one feeder 10 (FIG. 1). However, it is also conceivable that a feeder is assigned to two road pavers. The road paver serves to apply added material, such as, for example, asphalt, to a substrate, to distribute it in a more or less uniform manner there and to compact it in a suitable manner. The road paver has a supply container for material on a front end region. The material is successively removed from this supply container during the operation of the road paver and transported through the interior in particular to the lower, ground-adjacent region of the road paver into the region of the paving screed.

The material is supplied to the supply container of the road paver by the feeder 10. For this purpose, the feeder 10 has a conveying boom 11 with a primary conveyor 12 or main conveyor which extends along it. As viewed in the paving direction 13, the conveying boom is articulated on a rear end 14 of the feeder 10.

For movement purposes, the feeder 10 has a running gear, which here takes the form of a track-type running gear 16. As a drive for the running gear and the various units of the feeder 10, the latter has a dedicated drive unit 17 which typically takes the form of an internal combustion engine. In order to control the feeder 10, that is to say in particular the running gear and the primary conveyor 12, an operator's station 15 having operator-control elements 18 is provided.

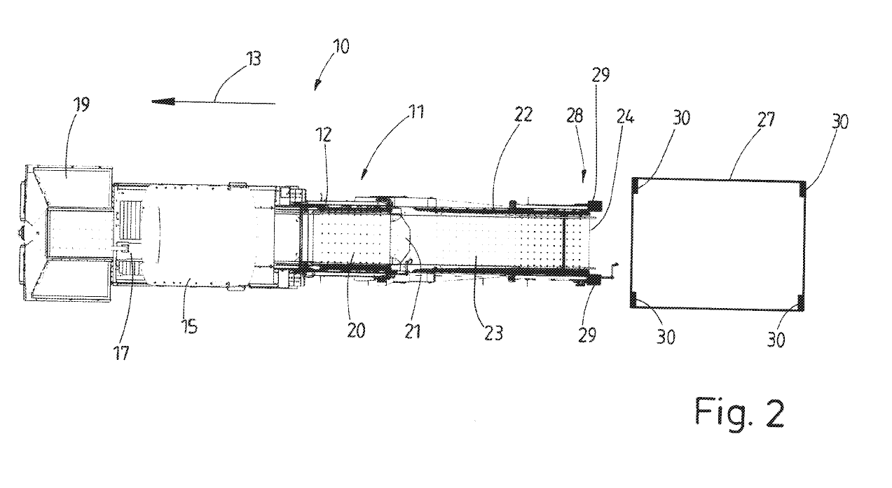

The feeder 10 has a supply container 19 on the front end region thereof. A transport vehicle (not shown here), such as, for example, a truck having a tiltable loading surface can pour a supply of the road-building material into this supply container 19. The material is then removed from the supply container 19 by a belt conveyor 20 of the primary conveyor 12. For this purpose, the belt conveyor 20 extends from the region of the supply container 19 into the region of the conveying boom 11 (FIG. 2). At the end of the conveying boom 11 or of the primary conveyor 12, the road-building material is ejected by a funnel-like chute 21 onto a pivoting conveyor 22.

This pivoting conveyor 22 is movably articulated on the rear end 14 of the feeder 10. The pivoting conveyor 22 likewise has a belt conveyor 23 which extends from a region below the chute 21 to an ejection point 24. To supply road-building material to road pavers which move alongside one another or to follow a relative movement of the road paver, the pivoting conveyor 22 can be pivoted both vertically and horizontally. For this purpose, the pivoting conveyor 22 has corresponding actuators or lifting cylinders 25, 26 by means of which the height of the ejection point 24 and the position relative to the supply container of the following road paver can be set.

In FIG. 2, a container 27 is symbolically indicated behind the feeder 10 with respect to the paving direction 13. For example, this container 27 can be the supply container of a road paver or the loading surface of a truck. During the feeding of a road paver with road-building material by the feeder 10, the road-building material is conveyed or ejected by the pivoting conveyor 22 into the container 27. Since the container 27 is fixedly connected to the road paver or to a truck, the container 27 follows the movement of the road paver or of the truck. Since different relative speeds or directions of travel can occur during the operation of the feeder and the road pavers, it is necessary that the pivoting conveyor 22 or the ejection point 24 is readjusted in its position relative to the container 27, specifically in such a way that the road-building material ejected by the pivoting conveyor 22 is conveyed at least to the greatest possible extent or completely into the container 27. For this purpose, the invention makes provision that, in the exemplary embodiment illustrated in FIGS. 1 and 2 of a feeder, the end 28 of the pivoting conveyor 22 is assigned sensor units 29. The sensor units 29, which are illustrated in a highly schematic form in the figures, can also be positioned on the feeder 10 at another position. These sensor units 29 can be designed as distance sensors, as optical sensors, as electromagnetic sensors, stereoscopic sensors or the like. The sensor units 29 are connected to a control unit (not shown). The control unit can serve, on the one hand, for the energy supply of the sensor unit 29 and/or for controlling or for reading the sensor unit 29.

The container 27 of the following road paver is detected by the sensor unit 29. However, there is also provision according to the invention that the at least one sensor unit 29 detects a plurality of containers 27 of following road pavers and determines the position and/or material filling level thereof. Control signals for the actuators of the pivoting conveyor 22 are generated by the control unit in dependence on the relative position of the container 27 to the pivoting conveyor 22 or to the ejection point 24 of the feeder 10. As soon as the relative position of the container 27 and of the ejection point 24 deviates from a predetermined value or from a predetermined corridor, the pivoting conveyor 22 is correspondingly readjusted in an automated manner by the control unit by activating the actuators, specifically until the predetermined positioning of the pivoting conveyor 22 relative to the container 27 is reestablished. This determination of the position of the container 27 or the automated readjustment can occur periodically during the operation or continuously. A readjustment of the pivoting conveyor 22 can also occur during the supply of two or more road pavers; here, the pivoting conveyor 22 is readjusted in alternation while in particular the material filling level of the container of the road paver which is not currently being fed with material is determined.

Furthermore, there can be provision according to the invention that the at least one container 27 additionally has at least one signaling means 30. This at least one signaling means 30 can be positioned at any desired point on the container 27. In the exemplary embodiment illustrated in FIG. 2 of a highly schematically illustrated container 27, each corner region of the container 27 has a signaling means 30. Such signaling means 30 can be optical, acoustic or electromagnetic signaling means which emit signals which can be detected by the sensor unit 29. The detection of the signaling means 30 by the sensor unit 29 means that both the position and the orientation of the container 27 can be clearly determined by means of the control unit (not shown).

This intermittent or continuous detection of the container 27 by the at least one sensor unit 29 proves to be particularly helpful in particular in the case of changing directions of travel of the road paver, in particular during cornering, but also when detecting a plurality of containers 27 of different road pavers. As soon as the road paver or the container 27 carries out an accelerated movement, this is detected by the at least one sensor unit 29, whereupon, on the one hand, the position of the ejection point 24 or of the pivoting conveyor 22 but also the speed of the feeder 10 per se can be adapted. Likewise, the conveying speed of the conveying boom 11 or of the belt conveyors 20, 23 can be changed with a change of the orientation of the container 27. Particularly if a driving maneuver of the road paver results in the container 27 being moved out of the field of view of the sensor unit 27, the material delivery of the feeder 10 can be stopped so that no road-building material falls onto the substrate.

There is also provision according to the invention that different positions of the pivoting conveyor 22 or of the ejection point 24 relative to a container 27 which are to be predetermined and stored can be stored or specified in the control unit. These stored positions can be not only the position of a container 27; rather, the invention makes provision that the positions of a plurality of containers 27 of different or various road-building machines are stored, in particular captured, called up and approached. As a result of an operator actuating a signal transmitter, such as, for example, a button, these fixed, predetermined positions can be reached in a simple and rapid manner by the actuators or by the lifting cylinders 25, 26. It is also conceivable that short pivoting maneuvers can be carried out by the input means in order to move the pivoting conveyor 22 into a defined position in movement sequences to be predetermined.

Even though the exemplary embodiment illustrated in the drawing illustrates a feeder 10, it should be expressly pointed out that the present invention can also be applied to other road-building machines, such as, for example, a road milling machine. In the case of a road milling machine, too, material is transferred from a primary conveyor to a following pivoting conveyor from which the milled-off material is transferred to a truck. Since also for this purpose the pivoting conveyor is pivoted relative to the primary conveyor, the same problem arises as illustrated above on the basis of the conveyor of a feeder. In this respect, the measures and features of the present invention illustrated by way of the drawing can be directly applied to a road milling machine.

### LIST OF REFERENCE SIGNS

10 Feeder

11 Conveying boom

12 Primary conveyor

13 Paving direction

14 Rear end

15 Operator's station

16 Track-type running gear

17 Drive unit

18 Operator-control element

19 Supply container

20 Belt conveyor

21 Chute

22 Pivoting conveyor

23 Belt conveyor

24 Ejection point

25 Lifting cylinder

26 Lifting cylinder

27 Container

28 End

29 Sensor unit

30 Signaling means

1. A method for operating a road-building machine, in particular a feeder (10) or a road milling machine, having a running gear and having a pivoting conveyor (22) which is pivotably fastened to the road-building machine, wherein material, in particular road-building material or milled-off road material, is conveyed by the pivoting conveyor (22) into a container (27) of at least one further construction vehicle which moves with or relative to the road-building machine, comprising detecting the container (27) of the at least one construction vehicle by at least one sensor unit (29) of the road-building machine.

2. The method for operating a road-building machine according to claim 1, further comprising, for a targeted pivoting or readjustment of the pivoting conveyor (22) or for determining a material filling level of the container (27), detecting the container (27) of the construction vehicle by the at least one sensor unit (29), preferably a stereoscopic camera, an imaging unit, distance sensors or the like.

3. The method for operating a road-building machine according to claim 1, further comprising determining the position, in particular the orientation, and/or the distance of the container (27) from the road-building machine by the at least one sensor unit (29).

4. The method for operating a road-building machine according to claim 1, further comprising pivoting the pivoting conveyor (22), in particular an ejection point (24) of the pivoting conveyor (22), relative to the container (27) of the further construction vehicle in an automated manner by a control unit, specifically on the basis of the position, in particular the orientation, and/or the distance of the container (27) from the road-building machine determined by the at least one sensor unit (29).

5. The method for operating a road-building machine according claim 1, further comprising, as a result of an operator actuating at least one signal transmitter, preferably a button, a touch panel or a remote control, reaching positions of the pivoting conveyor (22) relative to a longitudinal axis of the road-building machine in an automated manner by the pivoting conveyor (22), wherein the positions are specified in particular before putting the road-building machine into operation.

6. The method for operating a road-building machine according to claim 4, further comprising storing the positions of the pivoting conveyor (22), which are preferably specified before putting the road-building machine into operation, and/or control signals for actuators, in particular electrical, mechanical or hydraulic drives, for pivoting the pivoting conveyor (22) into the chosen position in at least one memory of the control unit and called up by actuating the signal transmitter, wherein the pivoting conveyor (22) is pivoted by the actuators into the chosen position in dependence on its current position.

7. The method for operating a road-building machine according to claim 1, further comprising pivoting the pivoting conveyor (22) from a first position into a chosen second position, wherein material conveyed during the pivoting of the pivoting conveyor (22) is ejected at least predominantly, preferably exclusively, into the container (27) of the at least one construction vehicle, and wherein for this purpose in particular the conveying speed of the pivoting conveyor (22) is at least temporarily adapted.

8. The method for operating a road-building machine according to claim 1, further comprising generating a warning signal by the control unit as soon as it is determined by the sensor unit (29) that the relative position of the container (27) to the pivoting conveyor (22) deviates from a predetermined position, in particular departs from a predetermined tolerance range for the position.

9. The method for operating a road-building machine according to claim 1, further comprising automatically readjusting the pivoting conveyor (22), preferably continuously, corresponding to the position of the container (27), by the control unit on the basis of the position of the container (27) determined by the sensor unit (29) by means of actuators, in particular electrical, mechanical or hydraulic drives.

10. The method for operating a road-building machine according to claim 1, further comprising determining the position of the container (27) by the at least one sensor unit (29) on the pivoting conveyor (22) by means of at least one, in particular electromagnetic, optical or acoustic, signaling means (30) which is arranged on the container (27), wherein the pivoting conveyor (22) is, where appropriate, readjusted in dependence on the position of the container (27).

11. A road-building machine, in particular feeder (10) or road milling machine, having a running gear and having a pivoting conveyor (22) which is pivotably fastened to the road-building machine, wherein, by virtue of the pivoting conveyor (22), material, in particular road-building material or milled-off road material, can be conveyed away by the pivoting conveyor (22) into a container (27) of at least one further construction vehicle which moves with or relative to the road-building machine, comprising at least one sensor unit (29), wherein the pivoting conveyor (22) has the at least one sensor unit (29), such as, for example, an imaging unit, a stereoscopic camera or a distance sensor, by means of which the container (27) of the construction vehicle can be detected for a targeted pivoting or a readjustment of the pivoting conveyor (22) or for determining the filling level of the conveyer (27).

12. The road-building machine according to claim 11, wherein the pivoting conveyor (22), in particular an ejection point (24) of the pivoting conveyor (22), is pivotable in an automated manner relative to the container (27) of the at least one further construction vehicle by means of a control unit, specifically in such a way that the conveyed material falls into the container (27).

13. The road-building machine according to claim 12, wherein the pivoting conveyor (22) is assigned at least one signal transmitter, preferably a button, a touch panel or a remote control, by the actuation of which the pivoting conveyor (22) is movable in an automated manner into a predetermined position relative to a longitudinal axis of the road-building machine.

14. The road-building machine according to claim 12, wherein the control unit has at least one data memory in which positions of the pivoting conveyor (22) which can be chosen by an operator and/or control signals for actuators, in particular electrical, mechanical or hydraulic drives, for pivoting the pivoting conveyor (22) into the chosen position is stored and is called up by actuating the at least one signal transmitter, wherein the pivoting conveyor (22) can be pivoted into the chosen position.

15. The road-building machine according to claim 12, wherein the pivoting conveyor (22) is correspondingly automatically readjusted, preferably continuously, by the control unit on the basis of the position, determined by the sensor unit (29), of the container (27) relative to the pivoting conveyor (22) by means of actuators, in particular electrical, mechanical or hydraulic drives.

16. The road-building machine according to claim 12, wherein the container (27) has arranged thereon at least one, in particular electromagnetic, optical or acoustic, signaling means (30) which is detectable by the at least one sensor unit (29) and the position of the container (27) relative to the pivoting conveyor (22) is determinable from the detected signals of the signaling means (30).
